(19) United States
(12) Patent Application Publication
(10) Pub. No.: US 2024/0378984 A1
(43) Pub. Date: Nov. 14, 2024

(54) REMINDER SYSTEM AND METHODS FOR WEARABLE APPLIANCES

(71) Applicant: Hailey Shaffett, Golden, CO (US)

(72) Inventor: Hailey Shaffett, Golden, CO (US)

(73) Assignee: Hailey Shaffett, Golden, CO (US)

(21) Appl. No.: 18/609,640

(22) Filed: Mar. 19, 2024

(51) Int. Cl. G08B 21/24

(52) U.S. Cl. CPC G08B 21/24

(57) ABSTRACT

A reminder system is described for wearable appliances. One example includes a case configured to contain a wearable appliance, a cover of the case to cover and protect the appliance, a timer attached to the case, the timer having an interface configured to receive a start command to start the timer and a stop command to stop the timer, and a transducer to provide an alarm when the timer expires.

### FIELD OF THE INVENTION

The present description relates to reminder systems and, in particular, to a reminder system for orthodontic, orthopedic, and other types of wearable appliances.

### BACKGROUND OF THE INVENTION

Orthodontia allows teeth to be slowly moved to a different position to improve jaw and mouth health, chewing and appearance. However, after the teeth have been moved, they tend to move back to the original positions at least until the new position is finally settled. Retainers are worn around the teeth to hold the teeth in place. These retainers interfere with eating and other activities and so are frequently removed for meals and for cleaning.

These and other orthodontic and orthopedic wearable appliances must be worn for a minimum amount of time in order to be effective. This time allows bones and related structures to settle or grow into a new place or shape.

### BRIEF SUMMARY OF THE INVENTION

A reminder system is described for wearable appliances. One example includes a case configured to contain a wearable appliance, a cover of the case to cover and protect the appliance, a timer attached to the case, the timer having an interface configured to receive a start command to start the timer and a stop command to stop the timer, and a transducer to provide an alarm when the timer expires.

### BRIEF DESCRIPTION OF THE DRAWINGS

The appended claims set forth the features of the invention with particularity. The present invention is illustrated by way of example, and not by way of limitation, in the figures of the accompanying drawings in which like reference numerals refer to similar elements.

FIG. 1 is an isometric diagram of an example of an opened case for holding a wearable appliance according to embodiments of the invention.

FIG. 2 is an isometric diagram of the case of FIG. 1 with the cover closed over the base according to embodiments of the invention.

FIG. 3 is an isometric diagram of an alternative retainer case including an additional manual switch according to embodiments of the invention.

FIG. 4 is a side cross-sectional view diagram of an alternative presence sensor in a case cover according to embodiments of the invention.

FIG. 5 is an isometric diagram of an alternative retainer case with the cover open and including the presence sensor of FIG. 4 according to embodiments of the invention.

FIG. 6 is a process flow diagram of reminding a user to wear an appliance after a set duration of time according to embodiments of the invention.

FIG. 7 is a process flow diagram of reminding a user to wear an appliance for a set duration of time according to embodiments of the invention.

FIG. 8 is a process flow diagram of using a wireless transceiver with an appliance case for reporting according to embodiments of the invention.

FIG. 9 is an example of an appliance case with a wireless transceiver according to embodiments of the invention.

FIG. 10 is a diagram of a network configuration for a connected appliance case according to embodiments of the invention.

### DETAILED DESCRIPTION OF THE INVENTION

A case is described that holds an orthodontic retainer, aligner, denture, or other dental prostheses or other orthopedic appliance. The case has an alarm or timer that is physically attached to or integrated with the case. The timer reminds the user to replace the appliance back in the mouth after a set time period. In some embodiments, the case may have a wireless data interface to connect and exchange data with one or more other wireless devices. The transmitted data might be used for review by the user, guardians, or dental professionals.

The case may be used in a variety of different usage scenarios. In one example, a user puts a retainer or aligner in the case before each meal and sets the timer. The timer alerts the user after the meal to return to the case and replace the appliance. Many retainers and aligners are intended to be worn all or most of the day and it is easy to forget to replace the retainer after a meal or other activity. The timer provides a reminder that the meal has ended and that the retainer should be replaced. In another example, the case has a switch or sensor for determining whether the retainer is in the case or being worn by the user. The case can then determine how much time the retainer is being used or is being stored in the case.

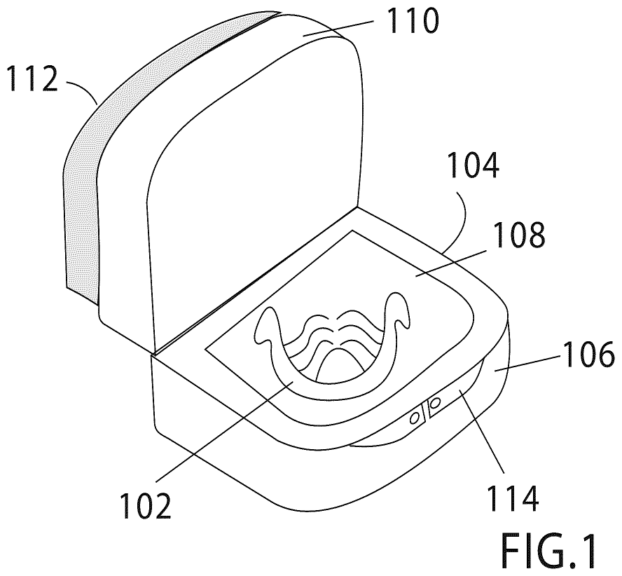

FIG. 1 is an isometric diagram of an example of an opened case for holding a retainer, aligner, denture or other orthodontic appliance. The appliance is also referred to as a retainer or appliance herein for case of reference, however, the invention is not so limited and may be applied to a variety of worn dental, orthodontic, orthopedic and similar types of appliances. As shown, the retainer 102 is stored in a case 104 case configured to safely hold the retainer. A conventional polyethylene or other type of plastic may be used or the case may be made of any other suitable material. The case has a base 106 with a well 108 to hold the retainer. The case also has a cover 110 that may be attached to the base with a hinge. The cover is configured to fit over the well to protect the retainer and attach to the base. A latch 114 holds the cover 110 over the base until released by a user or in another way. The latch may take the form of bendable plastic tabs to engage corresponding receptacles or ridges in the cover or any of a variety of other forms.

The cover also has a monitor system 112 attached to or integrated with the cover 110. The monitor system may be permanently or temporarily attached to the cover. The monitor system may also be integrated with the cover and with components of the cover. In some embodiments, the monitor system is removable from the cover and able to be carried independent of the cover. A removable monitor may be used when the user is not close enough to the case to hear the alarm. The monitor system may take a variety of different configurations as described in more detail below.

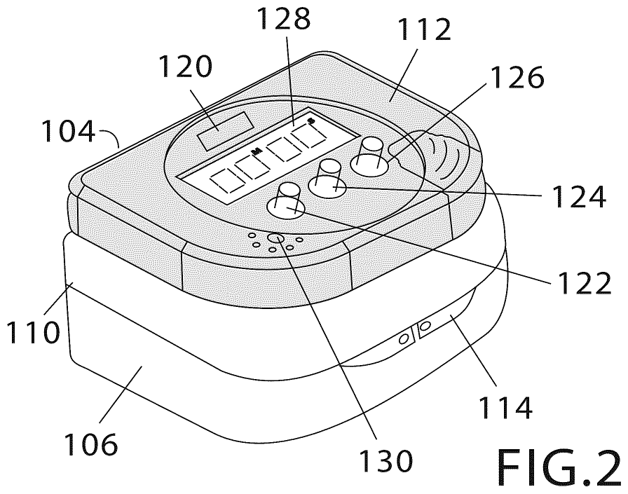

FIG. 2 is an isometric diagram of the case 104 of FIG. 1 with the cover 110 closed over the base 106 and held in place by the latch 114. The monitor system 112 is visible in the closed configuration. The monitor system has an internal processor or controller 120 and a user interface. In the present embodiment, the user interface includes buttons 122, 124, 126, a display 128, and a transducer 130 to provide an alarm when the timer expires. A dynamic speaker or piezoelectric transducer, such as a beeper, may be used for any type of audible alarm. Alternatively, the alarm may be rendered with other types of transducers, such as lights or operation of the display. As an example, the display may be made to flash with or without the use of a piezoelectric beeper. Any of a variety of other user interface designs may be used including touch screens, touch pads, lights, or audio interfaces to receive voice commands.

In this example, the monitor system includes a timer driven by the controller 120, such as a custom molded timer with a digital display 128 on the top 110 of the case 104 that is connected to the controller. The timer has a minute button 122, a second button 124, and a stop/start button 126 also connected to the controller. This allows a user to set a time duration by pressing the minute button and the second button and then start the timer by pressing the start button. Alternatively, the time duration may be pre-configured by a user or orthodontist so that the user presses only the start button. While a button is shown for showing seconds, different buttons may be used. For many of the described appliances, accuracy at a level of seconds is not required. The seconds button may accordingly be absent from some implementations and only two buttons may be required. An hours button may be provided instead or a button for any other desired function, including power, stop, start, reset, cancel, retainer presence, mode, preset timer durations, and display controls.

The start button commands the controller to initiate a timer routine. When time runs out, the controller causes a beep or other generated or recorded sound to be generated or retrieved and sent to the connected speaker 130. Vibrations, light flashes, and other indications may be used instead of or in addition to those described. The beep reminds the user to open the case 104, remove the retainer 102 from the case and put the retainer back on. In some implementations, the timer is a countdown timer and it generates an alarm when the selected time duration has expired. In other implementations, a count up timer may be used to show elapsed time. A count up timer may be set to generate an alarm when the elapsed time exceeds a set value. The timer may continue to count up, if desired so that the user can see the total elapsed time. Both timing functions may be provided as options with the same monitor system.

In one example, when the timer expires and the alarm is generated, the user presses the stop/start button to command the controller to stop the alarm sound. Another press may be used to restart the countdown from the same previous set time duration. Alternatively, the time duration may be adjusted using the minute and second buttons. In another embodiment, the case has a switch (not shown) in the cover connected to the controller to detect when the case has been opened so that opening the case is interpreted as a command to stop the alarm. The same switch may be used to prevent starting the timer until the cover is closed. In some embodiments, a snooze type command or button may be used to cancel the alarm for a set number of minutes after which the alarm sounds again.

The stopwatch or count up timer may also be used to measure elapsed time to track how long the retainer has been worn during the day. The controller may also be configured to log each time that the timer is set in order to determine how long the retainer is stored in the case. The total for each day, week, month, or other interval may be shown on the display. In another embodiment time in or out of the case is tracked in addition to the alarm time.

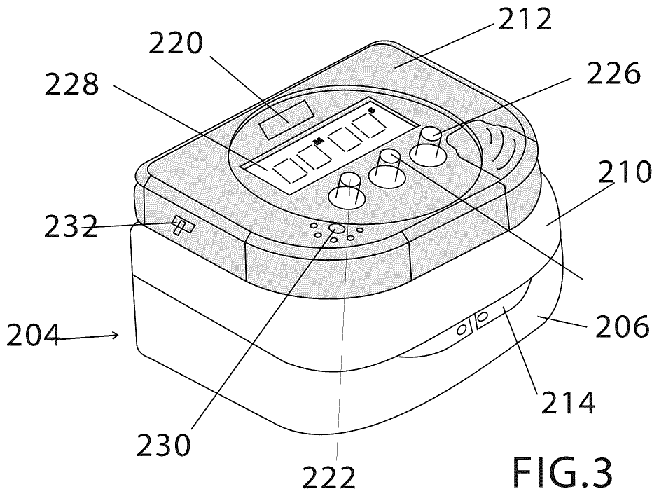

FIG. 3 is an isometric diagram of an alternative retainer case 204 including an additional manual switch 232. While the additional switch is shown on a side of the monitor module 212, the switch may be placed in any other location including near the other timer switches. As in FIG. 2, the case 204 has a base 206 and a top cover 210 configured to protect a retainer or other appliance inside the case. The cover is optionally held to the base with a latch 214 that is operable by the user to place or remove the retainer from the case. A monitor module 212 is attached to the cover 210 to provide monitor functions for the case.

The monitor module 212 has user input devices 222, 224, 226 such as pushbuttons, a display 228, and an audio output device 230 all connected to a controller 220 in the monitor module. These items may all operate in the same or a similar way to the corresponding items of FIG. 1. In addition, the monitor module has a presence sensor 232. In one example, the sensor is a manual switch that is toggled from a first position to a second position by the user when the user places the retainer in the case. The switch is toggled from the second position to the first position when the user removes the retainer from the case. In another example, the sensor is a pressure, contact, or optical sensor to determine the presence of the retainer in the case.

In another example, the latch 214 has a switch that is used to provide functions of the presence sensor. The latch may be used to determine whether the cover is opened or closed. When the cover is closed, the latch may include a switch or sensor to detect the position of the latch or of the cover. When the cover is opened and then closed, then the monitor module may be configured to infer that the retainer has been moved in or out of the case. The closed cover may be interpreted as a presence of the retainer or the movement of the cover may be interpreted as a change in the retainer presence. A switch in the latch or a switch in the cover that is operated by the latch may be coupled to the monitor module to affect the operation of the timer. Alternatively, the cover may have a switch in a different location to determine whether the cover is opened or closed. One example of such a switch is a pressure switch or pushbutton switch that is positioned in the cover at the rim near the base and configured to be operated by pressing the cover against the base.

As shown, the case may include both a latch 214 or other cover status sensor and a presence sensor 232. The latch or a closed cover may also be coupled to the monitor module and used as an alarm stop button. The timer may be configured so that if the user sets the timer with a closed cover, then the user can stop or cancel the timer by opening the cover. This may be done before or after the alarm is generated. A benefit of this configuration is that if the user takes the retainer out of the case before the timer expires, but forgets to stop the timer, then the alarm will not later be generated even though the user has already put the retainer back in the mouth.

The presence sensor is connected to the monitor module and may be used alternately to prevent or enable operation of the timer. As an example, when the retainer is placed in the case, its presence is detected and the timer is enabled. The user may then set the timer as a reminder to recover the retainer from the case and put it in the mouth. If the user has not yet placed the retainer in the case, then, in some embodiments, the timer cannot yet be started. As an alternative, the user may take the retainer out of the case and put it in the mouth and then set the timer to count how long the appliance is worn. In this example, the timer cannot be set until after the retainer is removed from the case.

In the example of FIG. 2, the timer start/stop button 126 may be used to determine how long the retainer is in the case. However, it may occur that the retainer is placed in the case but the user does not set the alarm or that the timer expires but the user does not remove and then wear the retainer. Using a retainer presence sensor, the monitor module may be able to more accurately track retainer use than by the timer alone. Using the presence sensor, the monitor module may track the time during which the switch is in the first position or during which the retainer is detected or not detected. This may be indicated as the amount of time that the retainer is being worn. Alternatively, the amount of time that the retainer is in the case may be used to indicate the amount of time that the retainer is not being worn. This information may be compiled by the monitor module, stored in a memory associated with the controller, and then retrieved through the user interface. This information may be complied by the controller of the monitor module separate and apart from any setting of the timer and stored in the controller memory. The type of information to compile may also be selected or controlled through the user interface.

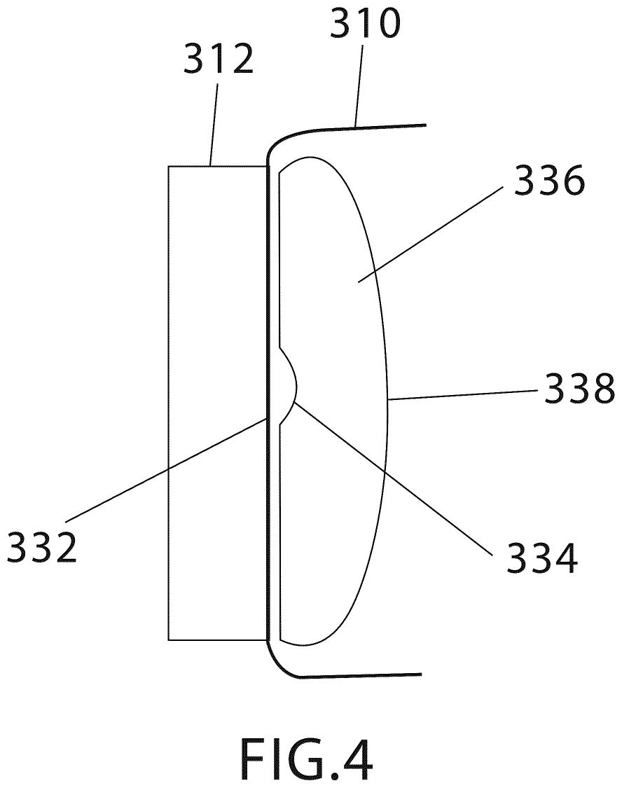

FIG. 4 is a side cross-sectional view diagram of an alternative presence sensor. In this example, the case top cover 310 has a monitor module 312 opposite the retainer. A switch 332 is attached to or integrated into the top cover. The switch may take any of a variety of different forms, but in this example is shown as having a pair of gaps in a conductive trace or wire. These serve as the contacts which are connected to each other by a conductive surface 334 that forms the blade of the switch. The conductive surface closes the circuit of the contacts to indicate the presence of a retainer in the case. The conductive surface is attached or applied to a flexible foam or other elastic polymer body 336 that is attached to the inside of the top cover 310 of the case.

In one example, the switch body 336 may be a low density foam or other elastic polymer added to an inside surface of the internal part of the case top cover. The foam has an electrically conductive backing 334. The shape of the foam is such that in its resting state there is a slight separation between the conductive surface of the foam and the exposed open circuit switch contacts 332. When the retainer is placed in the case and the cover is closed over the retainer, then the bottom surface 338 of the foam opposite the conductive backing 334 is pressed onto the retainer. The pressure of the retainer against the foam causes the foam backing 334 on the opposite side to press against the open circuit 332 and complete or close the circuit. This signal is coupled to the controller of the monitor module. The signal allows for data collection of “time in case” by the monitor module when the circuit is closed. The foam may have various layers of other materials to ensure a high accuracy for the presence sensor.

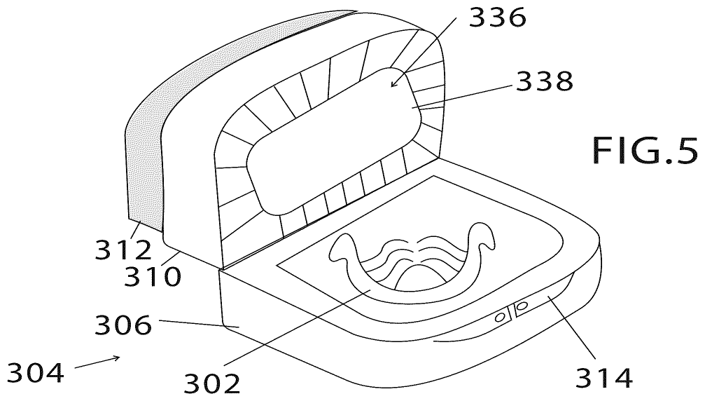

FIG. 5 is an isometric diagram of a case 304 with the appliance presence sensor 336 of FIG. 4. The case has a base 306 to hold the appliance 302. A cover 310 is attached to the base at a rear hinge and held in place with a latch 314. A monitor module 312 is attached to or a part of the case and is electrically connected to the presence sensor 336. As shown, the presence sensor is positioned in the cover so that as the cover is closed, the sensor is moved toward the appliance. The sensor is configured so that the bottom surface 338 contacts the appliance when the cover is closed.

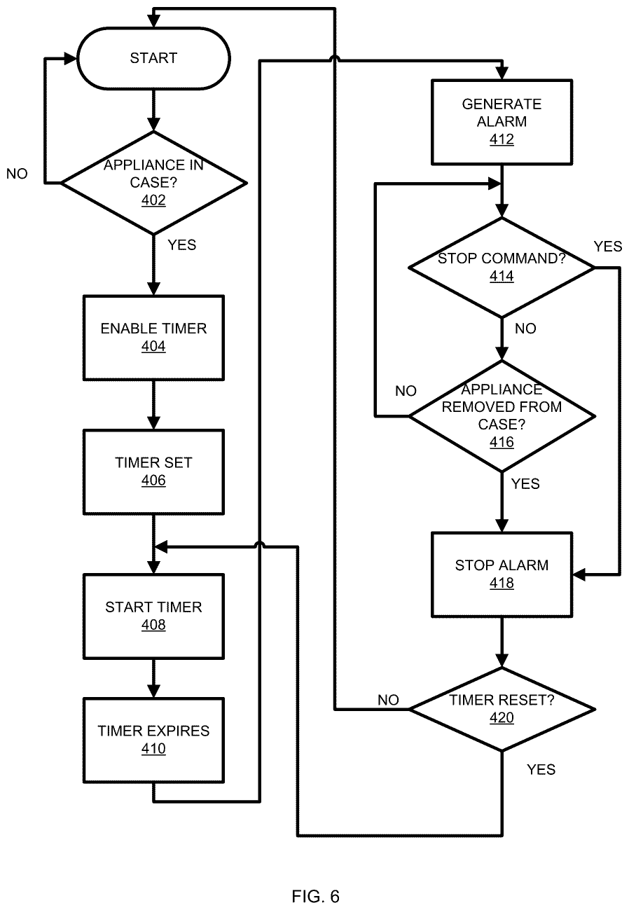

The devices described above allow for two primary uses with many variations to suit particular preferences. A first use is to remind the user to wear the retainer again after it has been removed for an activity such as eating a meal. This example is depicted in FIG. 6 as a process flow diagram of measuring the time elapsed when the appliance is not worn, or in other words of reminding a user to wear the appliance after a set duration of time.

The user removes the retainer from the mouth and places it in the case. At 402, the monitor system optionally detects whether the appliance is in the case and, if so, then at 404 enables the timer. If the appliance is not in the case, then the monitor system returns to wait until the appliance is in the case. With the timer enabled, the user sets the timer at 406. The monitor module controller receives this as timer setting commands. As an example, the user can use the minute and second buttons to set the timer for an estimated time of the activity, e.g. the duration of the meal. Alternatively, the monitor module may have a default timer setting or set the timer automatically. As an example, the monitor module may be configured to start the timer when the case cover is closed and the retainer is present. At 408 the timer is started and the count up or count down of the timer begins. After the set time duration has elapsed, then the timer expires at 410 and at 412 an alarm is generated. This alarm may be through a beeper, a speaker, flashing lights, transmitted wireless signals or any other suitable transducer. When the device makes an alarm sound, then the user can press the stop button on the device at 414, remove the retainer from the case at 416 and put it back in the mouth. Either one of the two actions may stop the alarm at 418. Alternatively, either the timer may be stopped only by the stop button issuing a command or by the appliance being removed. As mentioned above, the position of the cover may be used to determine whether the appliance has been placed in or removed from the case

Alternatively, if the user is not yet ready, then at 418 the user can either use the time buttons to add more time to the alarm or press the start button to renew the alarm at 408 for the same amount of time. In this way, the user is conveniently reminded to put the retainer back in after a meal or other activity.

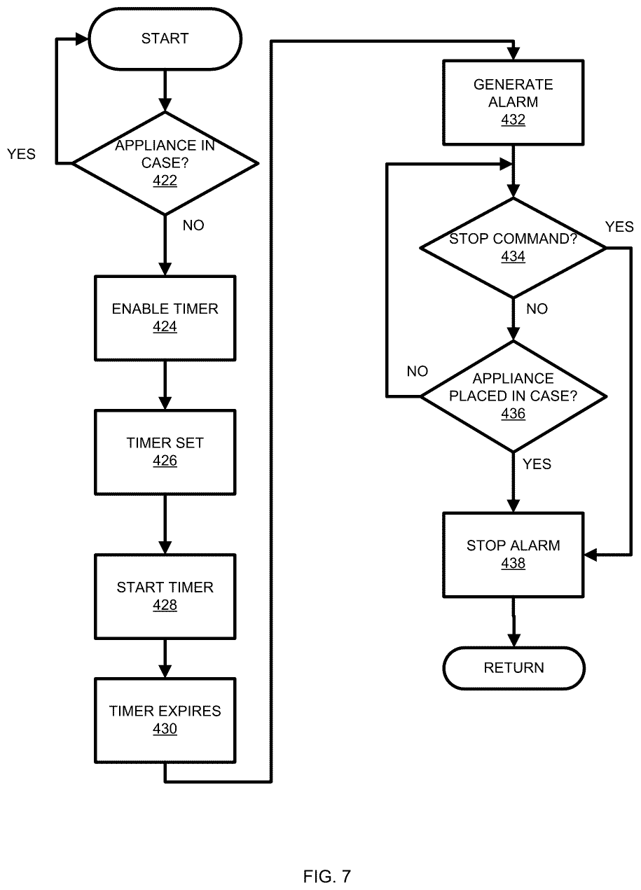

Another use is to help a user remember to wear the retainer for some selected minimum amount of time. This example is represented by the process flow diagram of FIG. 7. In this example, the user removes the retainer from the case at 422 and places it in the mouth. Removing the retainer may optionally be used as a condition for enabling the timer at 424. With the timer enabled, the user then uses the minute and second buttons or any other technique to set the timer at 426 for the selected minimum amount of time. In some cases, the monitor system may revert to the last alarm time setting so that the user is not required to set the time for each use. After the timer is set at 426, then it is started at 428 and counts up or counts down based on the setting. Alternatively, the monitor system may set the timer based on removing the retainer without any other user action and also start the timer. After the count is completed, the timer expires at 430 and the monitor system generates a suitable alarm at 432 as described above.

When the device makes an alarm sound, then the user is no longer required to wear the retainer and can remove it and place it back in the case for storage. The alarm may be stopped at 438 by the user issuing a stop command at 434 by, for example, pushing a stop button or opening the case. Alternatively, the alarm may be stopped at 436 when the appliance is detected as being in the case again.

In further embodiments, the operation of the monitor module of the case may be enhanced using a wireless transceiver as a part of the monitor module that communicates with other remote devices. The wireless transceiver may be used to transmit data for storage or review at a remote location. It may also or alternatively be used to enhance the timer functions described above.

In some embodiments the monitor module is augmented with a wireless interface to send and receive data to and from remote devices. A Wi-Fi, Bluetooth, LoRa (Long Range low data rate radio), or other radio system may be used for integration with a mobile device or phone app or for internet reporting. As mentioned above, the controller of the monitor module is able to compile an event log of timer and appliance presence events and to store these in a local memory. The controller may also be configured to interpret the events to determine an amount of appliance use and store appliance usage statistics. The statistics may be stored in the related memory. With a wireless interface, this usage information may be reported to a mobile device, e.g. using an app, local computer, cloud storage, or health care office.

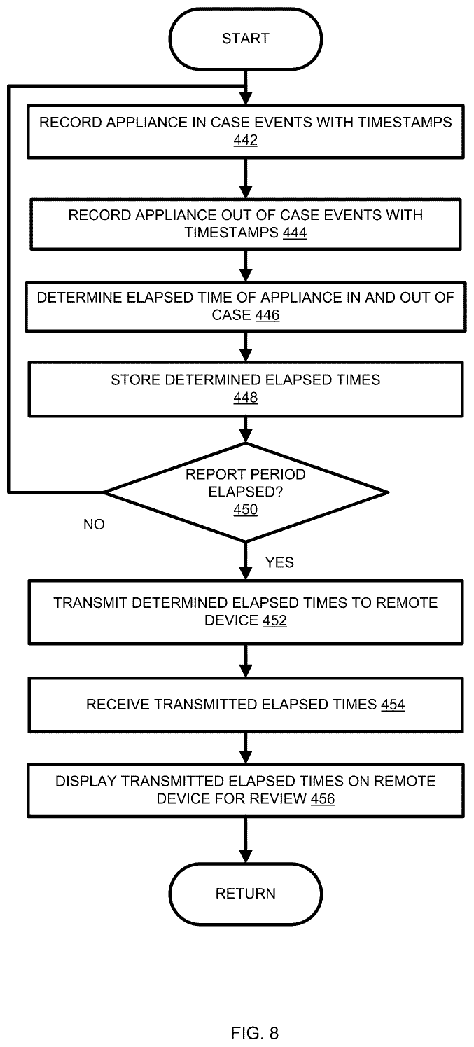

FIG. 8 is a process flow diagram of using a wireless transceiver with an appliance case for reporting. In this example, the Wi-Fi, LoRa, Bluetooth or other type of transceiver attempts a data transfer to a paired device at regular intervals. A designated application on a phone, computer, or server that is a receiving device may be used to receive, interpret, and store the reported data.

The case records activity with the appliance with timestamps. This data is then stored in the associated memory. The monitor module records when the appliance is placed into the case at 442 and when the appliance is removed from the case at 444. As mentioned, the presence of the appliance may be sensed directly, inferred from operation of the cover, or input by a user. One example of user input is for the user to toggle a switch or button to change the status of the retainer to match the reality of “in use” (in mouth) or “in case” each time the retainer is moved in or out of the case. At 446 the monitor module optionally determines elapsed times such as the time that the appliance has been in or out of the case. These times should relate to how long the appliance is being worn. As mentioned above, the monitor module may be configured to provide these determined times on the monitor user interface, such as on the display or to a user in other ways.

At 450 the monitor module runs a background process. This process may be limited only to those time when it is within range of or paired with a remote device. This process is to determine whether a reporting period has elapsed. The reporting period may be determined to minimize unnecessary transmissions, such as reporting every hour if the case is in range of a paired Bluetooth device, hotspot, router, or other network node. The monitor module continues to store data until it is able to send the data to the remote device. After the period has elapsed then at 452 the monitor module transmits the elapsed times that have been stored in the associated memory to the remote device. Alternatively, the event log may be transmitted so that the remote device determines any relevant elapsed times.

At 454 the remote device, such as the paired phone 544 receives the reported times and at 456 is able to display this data. The data might be used for review by the user, guardians, or dental professionals. The receiving remote device may also be configured to further send the received data to other remote devices, such as cloud services, or other concerned parties using text, e-mail, internet protocols, or a variety of file transfer protocols. Data transferred to the app and stored on the receiving device may be handled in the same way as data transferred through network/application servers. This data may be made accessible for review through various apps, email, or webpage reports in various forms and representations.

With a phone or other smart device paired with the case through e.g. Bluetooth or Wi-Fi, still more features may be provided, such as using an app on the phone or another device to trigger the alarm on the case if the case has been lost. A suitable app may be configured to allow alarm sounds or other features of the monitor module to be reprogrammed. In this case reprogramming or alarm commands may be sent through the app over Bluetooth directly to the case monitor module. Alternatively, the request may be sent from the app through a network to an application network server via an RF gateway and then to the case monitor module.

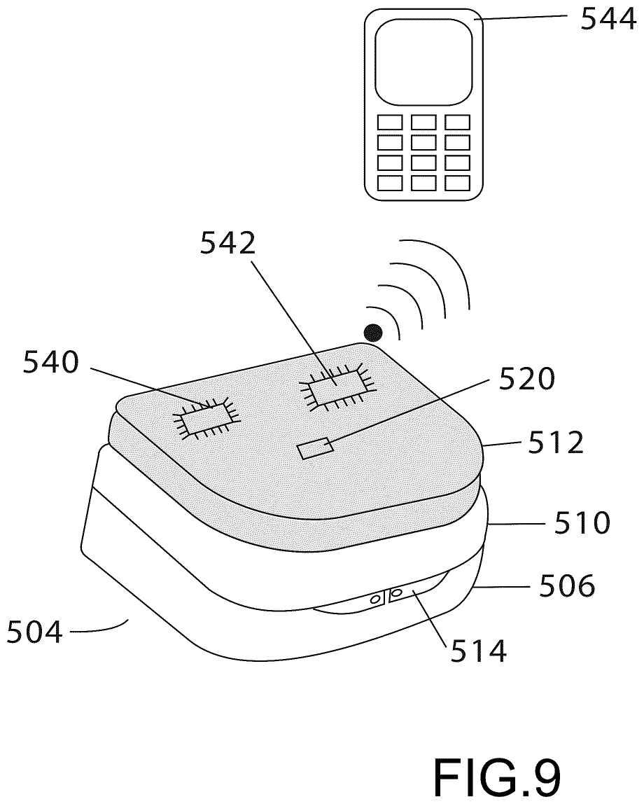

FIG. 9 is an example of an appliance case 504 with a base 506 and cover 510 to hold the appliance and a wireless transceiver to send data as described in the context of FIG. 8. A latch 514 may be configured to detect when the cover is opened and closed. There may be other appliance presence detectors. Alternatively, a manual switch may be used for a user to indicate when the appliance is in the case as in FIG. 3. A monitor module 512 of the case includes a controller 520 with a connected internal or external memory 540.

The monitor module also has a wireless transceiver 542 connected to the controller to communicate with remote devices. Any of a variety of different wireless transceivers may be used. The transceiver may be a discrete component or built on the same die or included in the same package with the controller, depending on the nature of the controller. A variety of controllers are currently available for Internet of Things (IoT) uses that contain a modest controller, memory, and low power radio. Any of these may be configured for the monitor module.

In some embodiments, a retainer or denture case with a built-in electronic alarm and data transceiver is configured to report the time and duration of retainer or denture usage to an internet or phone-based app. The operation of the device would be similar to what is described above. In addition, a Wi-Fi, LoRa, or Bluetooth feature reports data to a phone app, website, or other location. The reported information allows an individual or parent or health care provider to evaluate the time of retainer usage, and in the case of an orthodontist allows the orthodontist to better evaluate progress. The health care professional is then in a position to make better recommendations for further patient care.

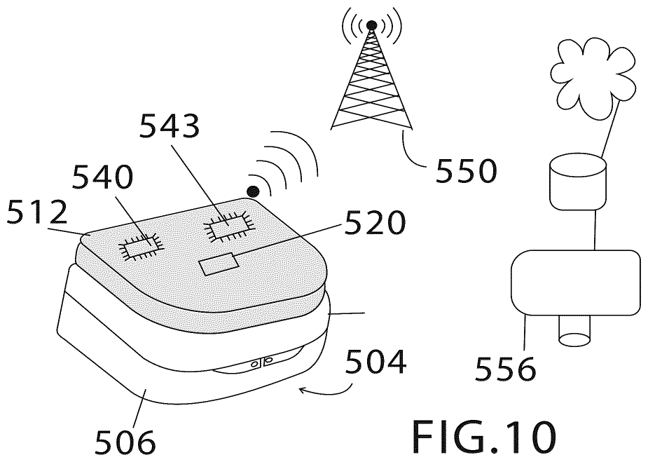

FIG. 10 is a diagram of a more extensive network configuration for a connected appliance case as described herein. In this example, the case 504 with base 506, cover 510 and monitor module 512 monitors activity with a controller 520 with associated memory 540 and transceiver 543. The transceiver sends monitor data periodically from the memory through a network antenna 550 that is coupled to the cloud 552, e.g., the Internet or another local or wide area network. Servers 554 or monitoring services are coupled to the cloud 552 to store the received data and provide it to computing and review stations 556 including patient, orthodontist, doctor, and service provider terminals.

The network of the antenna 550 may be a home network, a Bluetooth network, a cellular network, a LoRa network or any other network. The antenna may be connected to the cloud through a wired or wireless backbone. In some implementations, the RF (radio frequency) transceiver module 543 of the case 504 operates as an end node for data transfer to an RF gateway 550. The RF gateway passes the data to network/application servers 554 to make it available to users via https or similar customized apps or similar protocols to review on other devices 556.

While the steps described herein may be performed under the control of a programmed processor, in alternative embodiments, the steps may be fully or partially implemented by any programmable or hard coded logic, such as Field Programmable Gate Arrays (FPGAs), TTL logic, or Application Specific Integrated Circuits (ASICs), for example. Additionally, the methods described herein may be performed by any combination of programmed general purpose computer components or custom hardware components.

Therefore, nothing disclosed herein should be construed as limiting the present invention to a particular embodiment wherein the recited steps are performed by a specific combination of hardware components.

In the present description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form. The specific detail may be supplied by one of average skill in the art as appropriate for any particular implementation.

In one embodiment, the invention pertains to an apparatus that includes a case configured to contain a wearable appliance, a cover of the case to cover and protect the appliance, a timer attached to the case, the timer having an interface configured to receive a start command to start the timer and a stop command to stop the timer, and a transducer to provide an alarm when the timer expires.

In another embodiment the invention pertains to a process that includes receiving an orthodontic appliance in a case, receiving a start command at a timer attached to the case, starting the timer in response to receiving the start command, generating user-perceivable alarm upon expiration of the timer, receiving a stop command at the timer, and stopping the timer in response to receiving the stop command.

In another embodiment the invention pertains to a process that includes recording appliance in case events with timestamps at a wearable appliance case when the wearable appliance is placed in the case, recording appliance out of case events with timestamps at a wearable appliance case when the wearable appliance is removed from the case, determining whether a reporting period has elapsed, and transmitting data through a wireless transceiver of the case regarding the events from the case to a remote device if the reporting period has elapsed.

The present description includes various steps, which may be performed by hardware components or may be embodied in machine-executable instructions, such as software or firmware instructions. The machine-executable instructions may be used to cause a general-purpose or special-purpose processor programmed with the instructions to perform the steps. Alternatively, the steps may be performed by a combination of hardware and software.

Some of the described operations may be provided as a computer program product that may include a machine-readable medium having stored instructions thereon, which may be used to program a computer (or other machine) to perform a process according to the present invention. The machine-readable medium may include, but is not limited to optical disks, CD-ROMs, and magneto-optical disks, ROMs, RAMs, EPROMS, EEPROMs, magnet or optical cards, flash memory, or any other type of medium suitable for storing electronic instructions. Moreover, aspects of the present invention may also be downloaded as a computer program product, wherein the program may be transferred from a remote computer to a requesting computer by way of data signals embodied in a carrier wave or other machine-readable propagation medium via a communication link (e.g., a modem or network connection).

Importantly, while embodiments of the present invention are described with reference to timing use or storage of an orthodontic retainer, the method and apparatus described herein are equally applicable to other types of wearable appliances that must be worn for particular amounts of time. The case may be adapted to hold appliance with other shapes and sizes.

In the present description, for the purposes of explanation, numerous specific details are set forth in order to provide a thorough understanding of the present invention. However, the present invention can be practiced without some of these specific details. In other instances, well-known structures and devices are shown in block diagram form. The specific detail can be supplied by one of average skill in the art as appropriate for any particular implementation.

Although this disclosure describes illustrative embodiments of the invention in detail, it is to be understood that the invention is not limited to the precise embodiments described. The specification and drawings are, accordingly, to be regarded in an illustrative rather than a restrictive sense. Various adaptations, modifications and alterations may be practiced within the scope of the invention defined by the appended claims.

1. An apparatus comprising:
a case configured to contain a wearable appliance;
a cover of the case to cover and protect the appliance;
a timer attached to the case, the timer having an interface configured to receive a start command to start the timer and a stop command to stop the timer; and
a transducer to provide an alarm when the timer expires.

2. The apparatus of claim 1, wherein the timer is attached to the cover of the case.

3. The apparatus of claim 1, wherein the interface has a button to receive the start command and the stop command.

4. The apparatus of claim 1, wherein the transducer is a piezoelectric beeper.

5. The apparatus of claim 1, wherein the interface comprises a wireless interface to a portable device with a touchscreen and wherein the interface receives the start command from the touchscreen.

6. The apparatus of claim 1, further comprising a presence sensor to determine a presence the appliance is in the case and connected to the timer to alternately prevent or enable operation of the timer based on the sensed presence of the appliance in the case.

7. The apparatus of claim 1, wherein the presence sensor is a user-operated manual switch.

8. The apparatus of claim 7, wherein the presence sensor is operated by contacting an appliance in the case.

9. The apparatus of claim 1, further comprising a controller to log events of the appliance being removed from the case and a memory to store the log.

10. The apparatus of claim 9, further comprising a transceiver to store a representation of the logged events to a remote device.

11. A method comprising:
receiving an orthodontic appliance in a case;
receiving a start command at a timer attached to the case;
starting the timer in response to receiving the start command;
generating user-perceivable alarm upon expiration of the timer;
receiving a stop command at the timer; and
stopping the timer in response to receiving the stop command.

12. The method of claim 11, further comprising detecting a presence of the appliance in the case and enabling the timer in response to detecting the presence of the appliance.

13. The method of claim 11, further comprising detecting an absence of the appliance in the case and canceling the timer in response to detecting the absence of appliance retainer.

14. The method of claim 11, further comprising detecting an opening of a cover of the case and canceling the timer in response to detecting the opening.

15. The method of claim 11, further comprising detecting a closing of a cover of the case and enabling the timer in response to detecting the closing.

16. The method of claim 11, further comprising starting the timer after stopping the timer in response to receiving a user reset command.

17. The method of claim 11, further comprising detecting a presence of the appliance in the case; generating a log of the detected presence with a time stamp; and sending the log to a remote device through a radio transceiver.

18. A method comprising:
recording appliance in case events with timestamps at a wearable appliance case when the wearable appliance is placed in the case;
recording appliance out of case events with timestamps at a wearable appliance case when the wearable appliance is removed from the case;
determining whether a reporting period has elapsed; and
transmitting data through a wireless transceiver of the case regarding the events from the case to a remote device if the reporting period has elapsed.

19. The method of claim 18, further comprising determining an elapsed time of the appliance being in the case using the events with timestamps and wherein transmitting data comprises transmitting the determined elapsed time.

20. The method of claim 18, wherein the determined elapsed times indicate how much the wearable appliance is worn.
